(19) United States
(12) Patent Application Publication
(10) Pub. No.: US 2013/0212653 A1
(43) Pub. Date: Aug. 15, 2013

(54) SYSTEMS AND METHODS FOR PASSWORD-FREE AUTHENTICATION

(71) Applicant: Robert John Hoghaug, Prior Lake, MN (US)

(72) Inventor: Robert John Hoghaug, Prior Lake, MN (US)

(73) Assignee: Indigo Identityware, Edina, MN (US)

(21) Appl. No.: 13/490,298

(22) Filed: Jun. 6, 2012

Related U.S. Application Data
(60) Provisional application No. 61/596,968, filed on Feb. 9, 2012.

(51) Int. Cl. G06F 21/20

(52) U.S. Cl. 726/5

(57) ABSTRACT

Various systems and methods for implementing password-free authentication are described herein. A request to access a network resource is received at a server, from a client device. The request is verified, and an authentication reservation is created for the device, with the authentication reservation allowing the device to access the network resource. Later, when an attempt to access the network resource is received, the attempt is granted access to the network resource in response to matching information contained in the attempt with information stored in the authentication reservation.

### CLAIM OF PRIORITY

This application claims the benefit of priority under 35 U.S.C. §119(e) of U.S. Provisional Patent Application Ser. No. 61/596,968 filed on Feb. 9, 2012, which is incorporated by reference herein in its entirety.

### TECHNICAL FIELD

The present disclosure relates generally to user authentication and, in particular, to systems and methods for password-free authentication.

### BACKGROUND

In many enterprise-computing environments, particularly in government-regulated industries such as healthcare and financial services, information technology (IT) departments must comply with stringent security requirements or face possible penalties, including fines. Consequently, in an effort to increase network security, IT departments require users to either select and remember complicated passwords for their accounts, or use identification (ID) or proximity cards in addition to complicated passwords. As a result, the costs for providing helpdesk services to users who have forgotten their passwords or who have lost their ID/proximity cards increase. Furthermore, because the password policy forced onto the users requires passwords that are difficult for them to remember, many users may resort to security-compromising actions, such as writing passwords under mouse pads or on notes attached to computer monitors. This compromises network security and increases costs.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a system, according to an embodiment;

FIG. 2 is a block diagram illustrating modules of an authentication server, according to an embodiment;

FIG. 3 is a block diagram illustrating a local network implementation, according to an embodiment;

FIG. 4 is a block diagram illustrating a remote network implementation, according to an embodiment;

FIG. 5 is a block diagram illustrating another remote network implementation, according to an embodiment;

FIG. 6 is a flowchart illustrating a method for authenticating a user over a computer network, according to an embodiment;

FIG. 7 is a flowchart illustrating a method for authenticating a user over a computer network, according to an embodiment;

FIG. 8 is a flowchart illustrating a method for authenticating a user over a remote computer network, according to an embodiment;

FIG. 9 is a flowchart illustrating a method for authenticating a user over a computer network, according to an embodiment;

FIG. 10 is a flowchart illustrating a method for authenticating a user over a computer network, according to an embodiment; and

FIG. 11 is a block diagram illustrating a machine in the example form of a computer system, within which a set or sequence of instructions may be executed to cause the machine to perform any one of the methodologies discussed herein, according to an example embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

The present disclosure provides techniques and configurations used for providing password-free authentication.

Some enterprise computing users, particularly those in a healthcare setting, need fast and easy access to their computing resources. The current method used by medical professionals that move from room to room requires they logon to a workstation or thin client in each room they visit and then logoff as they leave. This scenario introduces a number of network security threats, including users forgetting to logoff when they are finished with a workstation as well as users writing down their network passwords because the passwords are too complicated for the users to remember.

Many clinics and hospitals provide access to sensitive data, such as patient medical records, through applications on virtualized computers, which reside in one or more servers. This virtual desktop infrastructure (VDI) has many benefits, including reduced desktop administrative and management tasks, centralization of computer security and data protection, and supporting access to virtual desktops from thin clients as well as from computers with fewer computing resources than necessary to run the virtualized applications.

However, for some users that are mobile throughout the day, using VDI may be cumbersome because the user may have to log in and log out of multiple workstations in addition to logging in and out of remote sessions on a VDI.

Generally, methods of authenticating a person involve having the person present one or more factors to prove the person's identity. Authentication factors may include one or more of the following: (1) Something a person knows (e.g., a password or personal identification number (PIN)); (2) Something a person has (e.g., a proximity card, smart card, or a password-generating token); (3) Something a person is (e.g., a biometric such as a fingerprint or iris scan). Single-factor authentication involves the use of one of these factors to verify a person's identity. Two-factor authentication involves the use of two of these factors to verify a person's identity. Multi-factor authentication involves the use of two or more of these factors to verify a person's identity. The strength of security in an authentication system increases with the number of factors used to prove a person's identity. Conventionally, when two or more factors are used, the mechanism is considered a “strong” authentication scheme.

Embodiments of the present disclosure are designed to address the challenging problem of providing strong authentication to users of enterprise devices. Some embodiments implement a single sign-on (SSO) service, including access to virtual desktops, once the enterprise device user has authenticated to the enterprise device.

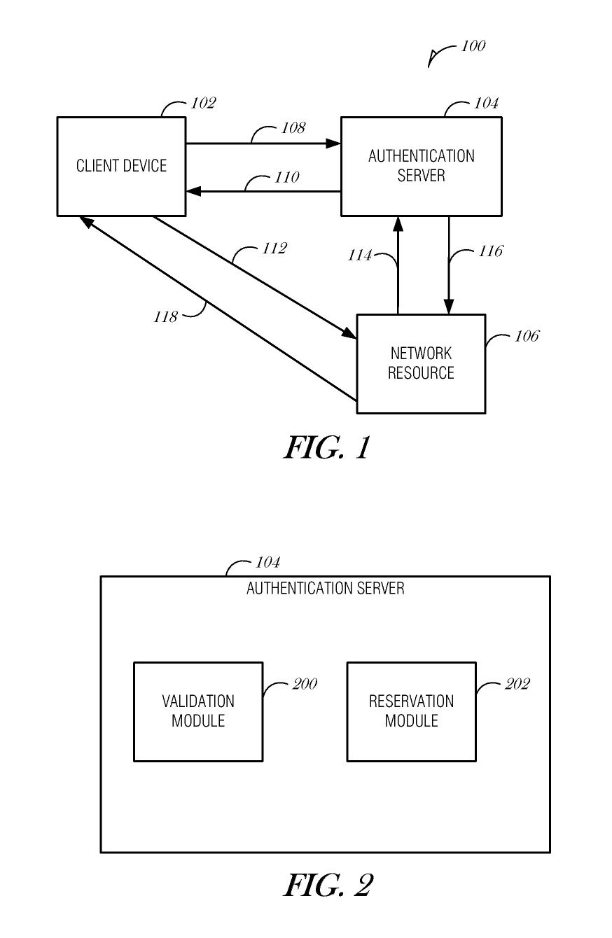

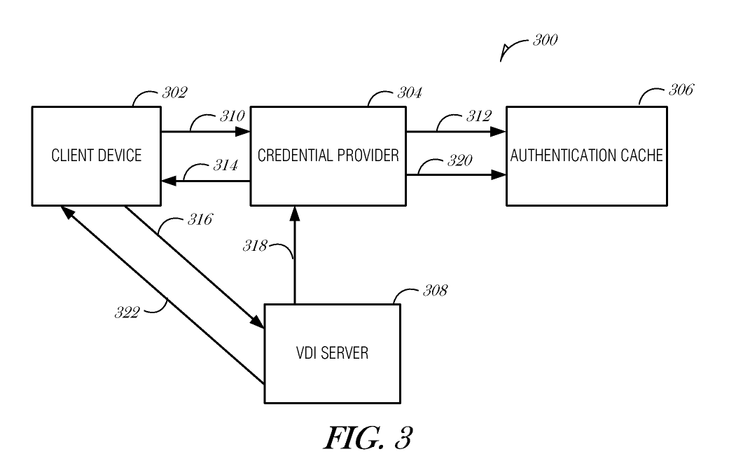

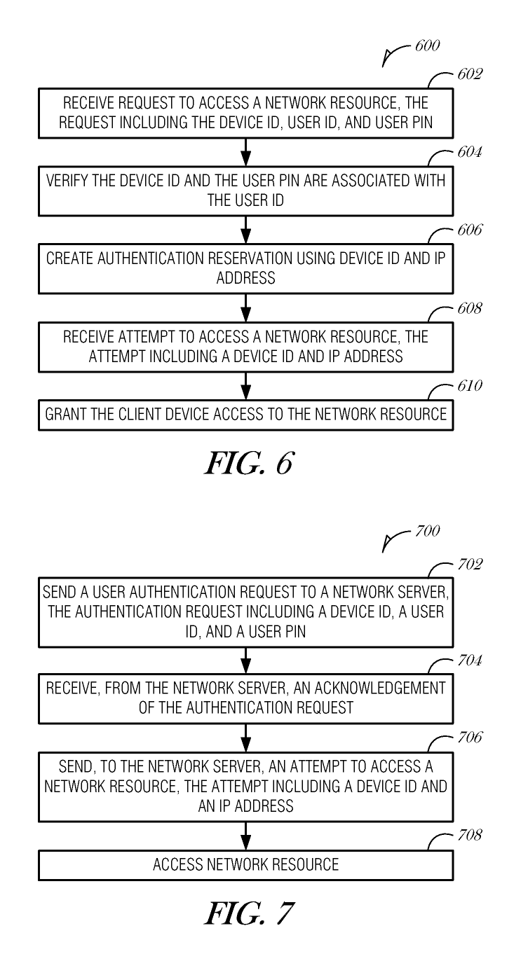

What is needed is a mechanism to streamline access to network resources. Examples of such mechanisms are illustrated and discussed in general in FIGS. 1-2, with specific instances in FIGS. 3-5. FIGS. 6-10 are flowcharts that describe example processes in accordance with the present disclosure.

FIG. 1 is a block diagram illustrating a system 100, according to an embodiment. The system 100 includes a client device 102, an authentication server 104, and a network resource 106. The client device 102 may be considered an endpoint computing device. In some embodiments, the client device 102 may be a mobile device such as an iPad®, tablet computer, laptop, or mobile phone. In some embodiments, the client device 102 may be a stationary computer such as a kiosk computer or a desktop computer. The client device 102 is operated by a user (not shown) who desires to access or use the network resource 106. In accordance with the embodiment illustrated in FIG. 1, the user may transmit a request 108 to the authentication server 104. The request includes information identifying the user and the client device 102. Information to identify the user may include one or more of a username, a password, a PIN, or other identifying indicia. The information identifying the client device may include one or more of a device identifier, which may be a globally unique identifier assigned to the device or generated by characteristics of the device. It is understood that any mechanism to generate an identifier for the device may be used, such as implementing a one-way hash that uses components installed in the device (e.g., hardware devices, software, operating systems, etc.) to create a device “fingerprint.” Other identifying information may be passed with the request 108, such as the Internet Protocol (IP) address of the device.

After receiving the request 108, the authentication server 104 validates the user's request 108 against a database. The database may be stored at the authentication server 104 or external from the authentication server 104. Validating the user may be performed by searching the database for the user's identifying information (e.g., username) and verifying that the client device 102 identification information is correlated with the user's identification. After validating the user-device pair, the authentication server 104 then creates a reservation for the user's request. The reservation acts to temporarily store the user's authentication state. The reservation may be active or valid for a relatively short period of time, such as twenty seconds. In some embodiments, the server may delete the reservation after the period of time has expired. In some embodiments, the server may have a setting for the period of time before a reservation expires. In such embodiments, the authentication server 104 may allow this reservation expiration to be set administratively. The reservation may be stored in a reservation database, which may be stored at the authentication server 104. The authentication server 104 responds to the request 108 with a response 110. The response 110 may inform the user of the success or failure of the authentication and provide additional information or instructions.

In the case when the user's authentication is successful, the user may then submit a request 112 to access the network resource 106 via the client device 102. In one example, the user uses a first software application to initiate the request 108 to the authentication server 104, and then a second software application to initiate the request 112 to the network resource 106. The first software application may be an authentication application that is aware of the password-free authentication system, while the second software application may be a remote-access application that is not aware of the password-free authentication system.

After receiving the request 112 to access the network resource 106, the network resource 106 queries 114 the authentication server 104 to verify that an active reservation exists that corresponds to the request. In an example, the network resource 106 receives the client device 102 identifying information and the IP address used by the client device 102 in the request 112. The network resource 106 provides the client device 102 identification and the IP address to the authentication server 104, which then queries the reservation database to check whether an active reservation exists. The authentication server 104 responds 116 to the network resource 106 with the results of the query.

If the authentication server 104 responds to the network resource 106 verifying that the client device 102 has an existing reservation, then the network resource 106 allows the client device 102 access. The network resource 106 responds 118 to the client device 102 with the appropriate information, indicating whether the request 112 to access the network resource 106 was successful. In some embodiments, the authentication server 104 may delete the authentication reservation after a number of unsuccessful authentication attempts. In some embodiments, the server may have a setting for the number of unsuccessful authentication attempts before the authentication server deletes the authentication reservation. In such embodiments, the authentication server may allow this number of unsuccessful authentication attempts allowable setting to be set administratively.

FIG. 2 is a block diagram illustrating modules of an authentication server 104, according to an embodiment. As shown in FIG. 2, there is a validation module 200 and a reservation module 202. The validation module 200 may be configured to receive a request from a user via a client device and validate that the user and client device are correlated. The validation module 200 may then respond to the user by sending appropriate information to the client device. After receiving an indication from the validation module 200 that the user and device are correlated, the reservation module 202 may create and store an authentication reservation. The validation module 200 may be further configured to receive a request to confirm that the user has a valid, active reservation. The request may come from a network resource, as discussed with respect to FIG. 1. The validation module 200 may confirm that the user has a valid, active reservation either independently or in conjunction with the reservation module 202. After receiving the results of the confirmation, the validation module 200 may communicate a response to the requestor (e.g., network resource 106). In addition, the modules 200, 202 may be configured to perform the operations discussed in the flowcharts below.

FIGS. 3-5 are discussed in the context of an environment where various server and client software applications are installed prior to user attempts to access enterprise systems. In an embodiment, an organization may install the following: a credential provider, which includes server-based software that may be used to authenticate users; an authentication cache, which includes server-based software that may be used to synchronize centrally located credential records; and a VDI server, which houses and executes virtual desktops or virtual applications on behalf of remote access clients. Examples of VDI servers are Citrix® XenDesktop® and XenApp®, the suite of products offered by VMware®, and the Remote Desktop Services/Terminal Services of Microsoft® Windows Server® 2008.

After the appropriate server-based software has been installed, a multi-factor-authentication manager (MFAM) may be installed by the organization on a workstation that is on the same network as the credential provider and the authentication cache. MFAM is an application for authenticating users using password-free multi-factor authentication. The organization may then use the MFAM on the workstation to enroll into the password-free authentication system those enterprise users who intend to use one or more independent (e.g., not administered by the organization) endpoint computing devices (e.g., client devices) to access secure network resources. At a workstation with the MFAM software installed, the IT department may enroll users into the password-free authentication system by having each user enter his or her network credentials (e.g., Active Directory username and password) into the MFAM software. Doing so may create a registration in the credential provider, thereby registering the user as a participant in the password-free authentication system. One such enrollment event may be sufficient to keep the user registered as a participant in the password-free authentication system indefinitely.

Upon registration as a participant in the password-free authentication system, a user may then download and install onto an endpoint computing device a client-side application that authenticates the user via the password-free authentication system. The client-side application contains profiles. In various embodiments, the target of each profile may be a particular computer, either physical or virtual, or a particular virtual application within the network. The client-side application may be installed with one or more preconfigured profiles. Upon installation of the client-side application, the user may create one or more profiles in the client-side application.

To create a profile within the client-side application, the user may enter the following information into the appropriate form of the client-side application: (1) a nickname for the target (e.g. a physical computer, virtual desktop, or virtual application) of the profile; (2) the fully-qualified domain name (FQDN) for the target; (3) the user's domain-based network username; (4) the user's domain-based network password; (5) the user's network domain; and (6) a PIN selected by the user for this profile. The PIN may be alphanumeric and may have a minimum length of four characters. Once the user has entered this information, the client-side application may connect (via a wireless or wired network connection) to the credential provider, and may send this information as well as a globally unique identifier (GUID) for the endpoint computing device to the credential provider. The GUID may reside in the hardware, firmware, or software of the endpoint computing device. The GUID may have been set by the manufacturer of the endpoint computing device or may be generated during installation of the client-side application. The GUID may or may not be obfuscated. If the domain-based network credentials match those registered with the credential provider during the user's enrollment, the credential provider may associate the endpoint computing device's GUID and the user-selected PIN with the user's domain account. Upon confirmation from the credential provider that the user entered the correct domain-based network credentials, the client-side application may then attempt to log the user into the target (e.g., physical computer, virtual desktop, or virtual application) of the profile. If the target login is successful, the client-side application will complete the creation of the profile and store the profile for future use by the user.

In an embodiment, a user may create profiles on multiple client devices, and multiple users may create profiles on the same client device. In this case, a many-to-many relationship exists between users and client devices. In another embodiment, a user may create profiles on multiple client devices, but only one user profile is allowed on a single device (e.g., each client device is limited to being associated with one user). In this case, a many-to-one relationship exists between client devices and users. In another embodiment, a user may create a profile on only one client device, but one or more other users may also create profiles on the same client device. In this case, a one-to-many relationship exists between client devices and users. In another embodiment, a user may create a profile on only one client device, and each client device is limited to storing profiles for only one user. In other words, there is a one-to-one relationship exists between client devices and users.

FIG. 3 is a block diagram illustrating a local network implementation 300, according to an embodiment. The implementation 300 includes a client device 302, a credential provider 304, an authentication cache 306, and a VDI server 308. The client device 302 may be a mobile device or a stationary computer, as described in FIG. 1. This workflow assumes both the user and the client device 302 have already been enrolled in the system. The credential provider 304 and authentication cache 306 may be arranged physically or logically in a shared server (e.g., authentication server 104). Alternatively, the credential provider 304 and authentication cache 306 may be geographically separated.

The client device 302 is operated by a user (not shown) who desires to access or use the VDI server 308 or processes, services, computers, or other network resources managed by the VDI server 308. When a user wants to access a particular target computing resource, (e.g. a physical computer, a virtual desktop, or virtual application) within the enterprise's network, the user may launch a client-side application previously installed on the user's client device. Within the client-side application, the user may then select the previously-created profile, whose target is the particular computing resource, enter the PIN associated with that profile, and then select a button instructing the client-side application to authenticate the user. The client-side application may then connect to the credential provider. The user may transmit a request 310 to the credential provider 304. In an embodiment, the request includes information identifying the user and the client device 302. Information to identify the user may include one or more of a username, a password, a PIN, or other identifying indicia. The information identifying the client device may include one or more of a device identifier, which may be a GUID assigned to the device or generated by characteristics of the device. For example, a GUID may be assigned to each device by a manufacturer at the time of manufacture. As another example, a one-way hash that uses components installed in the device (e.g., hardware devices, software, operating systems, etc.) to create a device “fingerprint” may be used to derive or obtain the device identification. It is understood that any mechanism to generate an identifier for the device may be used. Other identifying information may be passed with the request 310, such as the IP address of the device.

Although some examples described in this disclosure refer to a client device as a smartphone, it is understood that any user device may be used to provide the services and functions described herein. For example, a tablet computer, automobile navigation system, personal digital assistant (PDA), or a specialized device may be used.

After receiving the request 310, the credential provider 304 validates the user's request 310 against a database. The database may be stored at the credential provider 304 or external from the credential provider 304. Validating the user may be performed by searching the database for the user's identifying information (e.g., username) and verifying that the PIN and client device identification information is correlated with the user's identification.

After validating the user-device pair, the credential provider 304 then creates a reservation 312 for the user's request. The reservation acts to temporarily store the user's authentication state. The reservation may be active or valid for a relatively short period of time, such as twenty seconds. The reservation may be stored in the authentication cache 306. The reservation contains the IP address of the client device 302 and the identifying information of the client device (e.g., GUID). The IP address may be detected by the credential provider 304 at the time of the request 310. The credential provider 304 then responds to the request 310 with a response 314. The response 314 may inform the user of the success or failure of the authentication and provide additional information or instructions.

Following successful authentication by the credential provider 304, the user may have a short, administratively configurable window of time (e.g., less than 20 seconds) to launch the remote access client on the user's client device 302. As a result of launching the remote access client, a connection request 316 is submitted to the VDI server 308. As the remote access client connects to the VDI server 308, the VDI server 308, through the credential provider 304, accesses the authentication cache 306 to retrieve the user's access reservation established during authentication with the credential provider 304 (functions 318 and 320 in FIG. 3). The VDI server 308 may retrieve this reservation and use it to validate the connection request by verifying that the GUID and IP address of the client device sent by the remote access client match the reservation's GUID and IP address. Successful validation may grant access to a network resource under access control of the VDI server 308, while unsuccessful validation may deny access. If the validation is unsuccessful, in an embodiment, the user is presented with the conventional login screen to access the VDI server 308.

In an embodiment, the user uses a first software application to initiate the request 310 to the credential provider 304, and then a second software application to initiate the request 316 to the VDI server 308. The first software application may be an authentication application that is aware of the password-free authentication system, while the second software application may be a remote-access application that is not aware of the password-free authentication system.

The VDI server 308 responds 322 to the client device 302 with the appropriate information, indicating whether the request 316 to access the VDI server 308 was successful.

In some embodiments, access via a reservation may be limited to a single validation attempt. If the validation attempt fails, the reservation may be deleted from the authentication cache 306. If the user continues to desire to access the target of the profile, the user may have to start from the beginning by selecting a profile within the client-side application and entering his or her PIN for the selected profile.

Endpoint computing devices with non-static IP addresses are subject to having their IP address changed periodically (e.g., through Dynamic Host Configuration Protocol (DHCP)). Although the IP address of the endpoint computing device is used as part of the authentication process, the IP address is unlikely to change during the short window of time that the user has to establish a connection to the VDI server 308.

In addition to requiring strong passwords, most managed IT networks require users to change their passwords periodically. This can be another source of user frustration because users may have difficulty creating new passwords that comply with the strong password policy. Furthermore, helpdesk costs may increase because users may choose passwords that comply with the strong password policy but are too complicated for users to remember. Embodiments described herein address this problem by periodically changing the user's network password automatically. Password changes may be transparent to the user because the user connects to the network's computing resources using the password-free authentication system, which associates the user's enrolled profile(s) with the user's network account and has the user enter a PIN, not the user's network password.

The password-free authentication system may also be configured to allow client device users to access network resources from outside an enterprise network. To facilitate this capability, server-side elements are introduced; specifically, a web application or web service is introduced, which will permit the client-side application on the client device to request a one-time password (OTP). In addition, an authentication back-end to Remote Authentication Dial In User Service (RADIUS), which permits OTP verification by a RADIUS server, may be used. The enrollment process for each client device may remain the same as in the implementation described in FIG. 3.

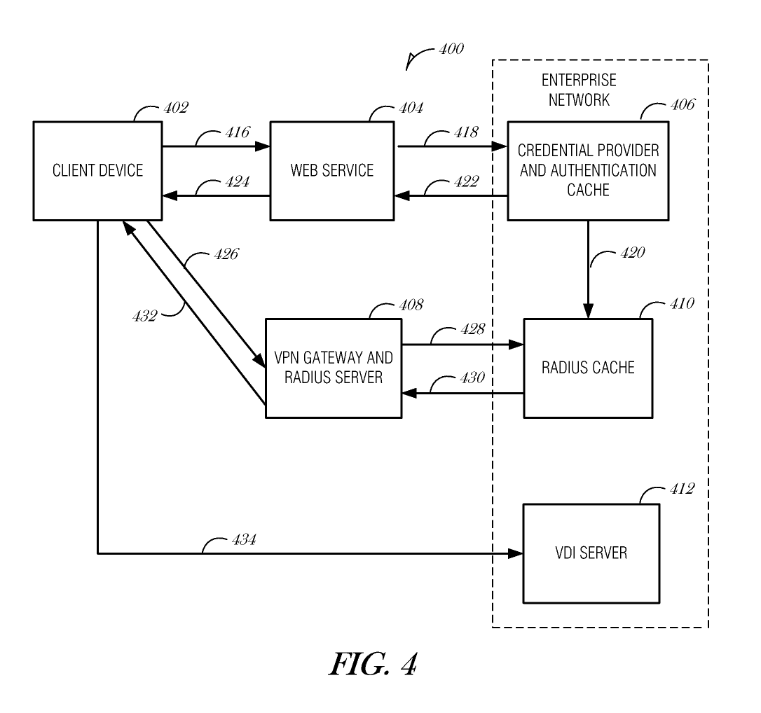

FIG. 4 is a block diagram illustrating a remote network implementation 400, according to an embodiment. The implementation 400 includes a client device 402, a web service 404, a credential provider 406, a virtual private network (VPN) gateway and Remote Authentication Dial-In User Service (RADIUS) server 408, a RADIUS cache 410, and a VDI server 412. This workflow assumes both the user and the client device 402 have already been enrolled in the system. The client device 402 may be a mobile device or a stationary computer, as described in FIG. 1. The client device 402 is operated by a user (not shown) who desires to access or use the VDI server 412. In accordance with the embodiment illustrated in FIG. 4, the client device 402 is outside of the enterprise network.

Similar to the implementation 300 in FIG. 3, the user may begin by using a client-side application on the client device 402 to request an OTP from the web service 404. Thus, in accordance with the embodiment illustrated in FIG. 4, the user may transmit, via the client device 402, a request 416 to the web service 404. As with the implementation 300 in FIG. 3, the request may include information identifying the user and the client device 402.

The web service 404 may then communicate 418 with the credential provider 406 to obtain an OTP from the credential provider 406. After receiving the communication 418 of the request 416, the credential provider 406 may validate the user's request 416 against a database in order to ensure that the user's identification is associated with the client device identification information. The database may be stored at the credential provider 406 or external from the credential provider 406. Validating the user may be performed by searching the database for the user's identifying information (e.g., username) and verifying that the client device 402 identification information is correlated with the user's identification. After validating the user-device pair, the credential provider 406 then creates a reservation for the user's request. The reservation acts to temporarily store the user's authentication state. The reservation may be active or valid for a relatively short period of time, such as 20 seconds. The reservation may be stored in an authentication cache, which may be stored at the credential provider 406.

The credential provider 406 also creates an OTP and stores 420 the OTP at the RADIUS cache 410. Generating strong OTPs requires generating a seed with a high degree of randomness. The seed may be created by software, by hardware, or by a combination of hardware and software. Once created, the seed may then be used in one or more algorithms to create a strong OTP. The credential provider 406 then responds 422 to the request 416 via the web service 404. The response 422 may inform the user of the success or failure of the authentication and provide additional information or instructions and, in the case of a successful authentication, may contain the OTP. The web service 404 communicates 424 the response 422 to the client device 402.

Upon receiving the OTP from the web service 404, the user may have a short, administratively configurable window of time to connect, using a VPN, to the remote access target. The user may then establish a VPN connection to the network's VPN gateway 408 using the OTP. For example, the user may send a VPN connection request 426 to the VPN gateway 408. The VPN connection request 426 includes information identifying the user and the client device 402, such as a username, a password, a PIN, a device identifier, and an IP address of the device. The VPN connection request 426 also includes the OTP received from the credential provider 406.

The VPN gateway 408 may then make an authentication request 428 of the RADIUS server (not shown). The RADIUS server may compare the OTP sent by the VPN gateway 408 against the OTP in the RADIUS cache 410. The RADIUS cache 410 then sends 430 the result of the OTP comparison to the VPN gateway 408. If the two OTPs match, the VPN gateway 408 may grant access to the client device 402. If the two OTPs do not match, the VPN gateway 408 may deny access to the client device 402. After granting or denying VPN access, the OTP may be removed from the RADIUS cache 410. The VPN gateway 408 sends a response 432 to the client device 402, informing the client device 402 of the success or failure of establishing a VPN connection.

If the response 432 indicates the VPN connection was successfully established, client device 402 may then access the VDI server 412 by sending a connection request 434 through the VPN connection. For example, the user may launch a remote access connection through the VPN to the target computing resource. Upon a successful authentication to the target computing resource through VPN, the user may access network resources as if the user were inside the network.

VPN IP addresses come from a known pool. When the credential provider creates the VDI reservation, it may provide an IP mask from the VPN pool. For added security, when the user connects to the target computing resource, the source IP from the VPN address pool may be validated against the mask.

Although the typical target of a remote access client is a virtual desktop or virtual application, a target of a remote access client may also be a physical computer. In various embodiments, the password-free authentication system may be configured to allow enterprise endpoint computing device users to connect, using a remote access client, to physical computers, virtual desktops, or virtual applications. In some embodiments, the password-free authentication system may be configured to allow enterprise endpoint computing device users to connect, using a remote access client, only to virtual desktops and virtual applications.

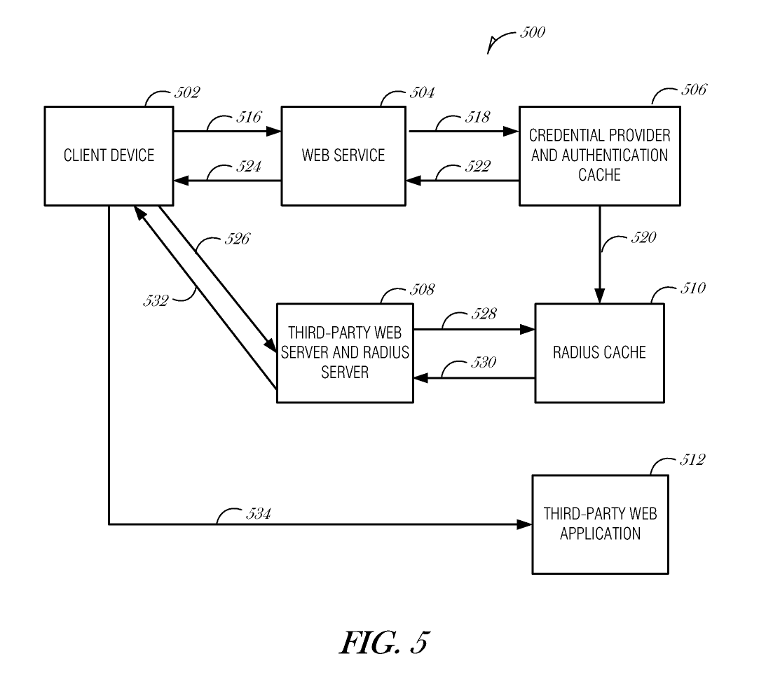

FIG. 5 is a block diagram illustrating another remote network implementation 500, according to an embodiment. The implementation 500 includes a client device 502, a web service 504, a credential provider 506, a third-party web server and RADIUS server 508, a RADIUS cache 510, and a third-party web application 512. The client device 502 may be a mobile device or a stationary computer, as described in FIG. 1. The embodiment illustrated in FIG. 5 operates similarly to the embodiment illustrated in FIG. 4, but instead of a VPN gateway 408, the implementation 500 in FIG. 5 uses a third-party web server 508, and instead of a VDI server 412, the implementation 500 in FIG. 5 uses a third-party web application 512. For example, in the implementation 500 in FIG. 5, a user request 516 is received by the web service 504 and authenticated by the credential provider 506 (transactions 518, 522, and 524). Upon successful authentication, an OTP is created and then stored 520 at the RADIUS cache 510. The OTP is used to validate a connection request received at the third-party web server and RADIUS server 508. Upon validating the connection request (transactions 526, 528, 530, and 532), the client device 502 is allowed access 534 to the third-party web application 512.

In an embodiment, the client device in FIGS. 3-5 may be an Apple® iPad®. The iPad® is rapidly growing as a client device in healthcare. The iPad® operates on an entirely different technical foundation from Microsoft® Windows®. One of the key architectural differences is the significant limitation iPad® places on the ability for applications to interact. Application interaction is a mainstay of SSO systems. The ability for SSO systems to monitor desktop and application activity in order to manage authentication processes is fundamental to the effectiveness of modern SSO systems. By limiting application interaction, iPad® has closed the door on a primary mechanism by which SSO is typically accomplished.

In order to address this, as discussed above, a client software program is installed that the user may execute to authenticate and create a reservation. When the client software is installed, a value that uniquely identifies the device (e.g., device ID) is created or obtained. The iPad® includes a unique identifier assigned at the time of manufacture, known as the unique device identifier (UDID). The UDID is a hardware characteristic of the iPad® and not subject to change. A system call to the iPad®'s operating system is used to obtain the UDID. Thus, in an embodiment, the iPad®'s UDID may be used as the device identification information. Alternatively, the installation process of the client-side application may invoke an application programming interface (API) to generate a GUID. For example, the client-side application may make a system call to the operating system in order to generate a unique identifier that is not the UDID. Alternatively, the client-side application itself may generate the GUID. For example, the GUID may be based on one or more hardware or software assets installed on the iPad®. Once generated, the GUID may be stored in the client device and used as the device's identification information.

Then, as discussed above, in order to authenticate to a VDI session from an iPad®, a user executes the client software and selects a preconfigured authentication profile for the user's target VDI system and enters his or her PIN. The client software connects to a credential provider that authenticates the user, verifying the UserID, PIN, and a unique identifier from the iPad®. If authentication is successful, a reservation is created, storing the device's GUID and IP address of the iPad® (detected during the authentication process). The user has a small, administratively configurable number of seconds (e.g., five to ten seconds) to switch to the VDI client and establish a connection. When the VDI client connects, the credential provider on the VDI desktop accesses the reservation cache for the connecting user. If the reservation is present, the GUID and IP address are validated. If successful, the user is logged in. If unsuccessful, the user is presented with the conventional login screen. In either case, the reservation is removed from the cache. Whether or not it is successfully validated, a reservation can only be accessed once.

FIG. 6 is a flowchart illustrating a method 600 for authenticating a user over a computer network, according to an embodiment. At block 602, a request to access a network resource is received at a server, from a client device. The request may include an ID unique to the client device, a user ID of the user, and a PIN of the user.

At block 604, the device ID and the PIN are verified as associated with the user ID. The verification may be performed by the server.

At block 606, an authentication reservation for the device is created, where the authentication reservation allows the device to access the network resource, and where the authentication reservation includes the device ID and an IP address from which the client device sent the device ID, user ID, and PIN.

At block 608, an attempt to access a network resource is received. The attempt may include the device ID and the IP address of the client device.

At block 610, the client device is granted access to the network resource in response to the device ID from the request matching the device ID from the attempt and the IP address from the request matching the IP address from the attempt.

In a further embodiment, the method 600 comprises deleting the authentication reservation after a period of time. In a further embodiment, the method 600 comprises accessing a setting and configuring, at the server, the period of time, after which the authentication reservation is deleted.

In a further embodiment, the method 600 comprises denying the client device access to the network resource in response to the user ID in the authentication reservation not matching the user ID obtained from the attempt, or the IP address in the authentication reservation not matching the IP address obtained from the attempt.

In a further embodiment, the method 600 comprises deleting the authentication reservation after a number of unsuccessful attempts to access the network resource. An unsuccessful attempt to access the network resource may comprise the user ID in the authentication reservation not matching the user ID obtained from the attempt, or the IP address in the authentication reservation not matching the IP address obtained from the attempt. In a further embodiment, the method 600 comprises accessing, at the server, a setting and configuring the number of unsuccessful attempts, after which the authentication reservation is deleted.

In a further embodiment, the method 600 comprises receiving, at the server, encrypted communications from the client device and sending, from the server, encrypted responses to the client device.

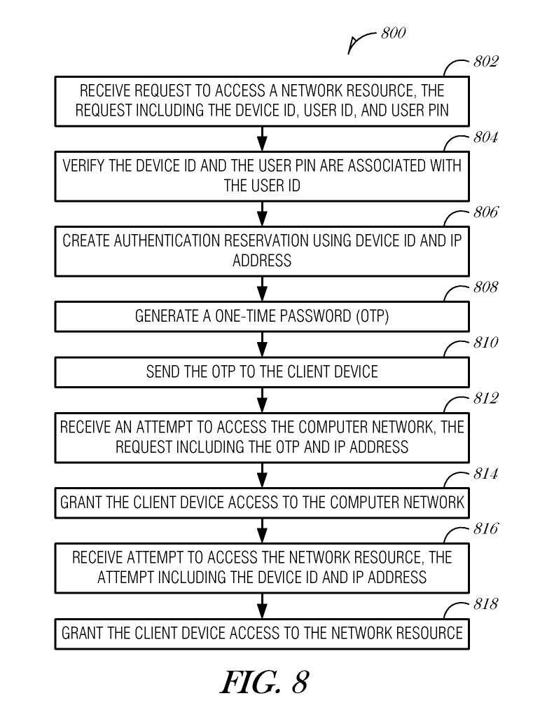

FIG. 7 is a flowchart illustrating a method 700 for authenticating a user over a computer network, according to an embodiment. At block 702, a user authentication request is sent to a network server from the client device with a first IP address, where the user authentication request includes a device ID unique to the client device, a user ID for a user associated with the client device, and a PIN associated with the user.

At block 704, an acknowledgment from the network server of the receipt of the authentication request is received by the client device.

At block 706, a request to access a network resource is sent by the client device to the network server. The request may include the user ID of the requesting user and the IP address of the client device.

At block 706, an attempt to access the computer network is sent to the network server from the client device with a second IP address, with the attempt comprising a second device ID. In an embodiment, the attempt to access the computer network is performed through a remote desktop client. In an embodiment, the attempt to access the computer network is performed through a virtual desktop client.

At block 708, the network resource is accessed by the client device upon both the first device ID in the user authentication request matching the second device ID in the attempt to access the computer network and the first IP address in the user authentication request matching the second IP address.

In an embodiment, communications between the network server and the client device are encrypted.

In an embodiment, the user reenters the user PIN before sending the attempt to access the computer network to the network server.

FIG. 8 is a flowchart illustrating a method 800 for authenticating a user over a remote computer network, according to an embodiment. At block 802, a request to access a network resource is received at a server, from a client device. The request may include a device ID unique to the client device, a user ID of the user, and a PIN of the user.

At block 804, the device ID and the PIN are verified to be associated with the user ID. The verification may be performed by the server.

At block 806, an authentication reservation for the device is created, where the authentication reservation allows the device to access the network resource, and where the authentication reservation includes the device ID and an IP address, from which the client device sent the device ID, user ID, and PIN.

At block 808, an OTP is created.

At block 810, the OTP is sent to the client device.

At block 812, an attempt to access the computer network is received. The attempt may include the OTP and the IP address of the client device.

At block 814, the client device is granted access to the computer network in response to the generated OTP matching the OTP from the attempt to access the computer network. As an additional security precaution, access to the computer network is granted to the client device upon the IP address in the authentication reservation matching the IP address from the attempt to access the computer network.

At block 816, an attempt to access the network resource is received. The attempt may include the device ID and the IP address of the client device.

At block 818, the client device is granted access to the network resource in response to the device ID and IP address from the request to access the network resource matching the device ID and IP address from the attempt to access the network resource.

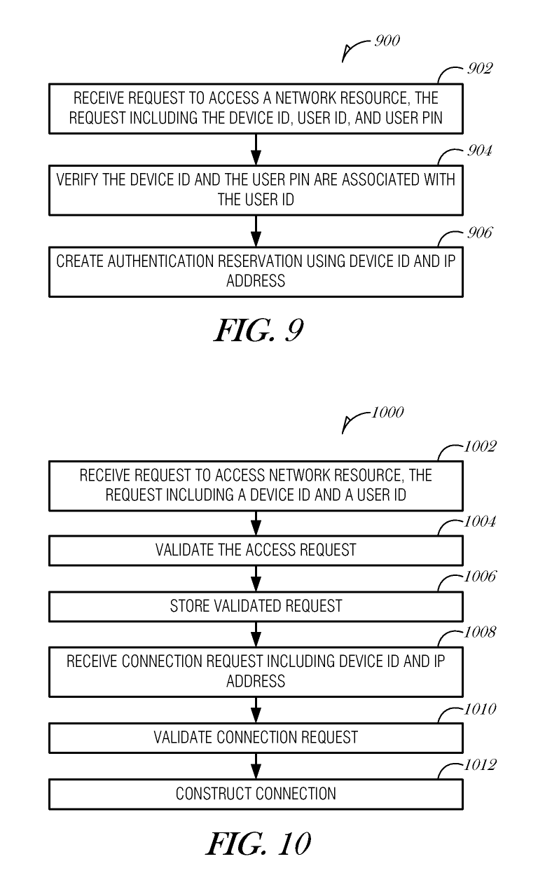

FIG. 9 is a flowchart illustrating a method 900 for authenticating a user over a computer network, according to an embodiment. At block 902, a request to access a network resource is received at a server, from a client device. The request may include a device ID)unique to the client device, a user ID of the user, and a PIN of the user. At block 904, the device ID and the PIN are verified to be associated with the user ID. The verification may be performed by the server. At block 906, an authentication reservation for the device is created, where the authentication reservation allows the device to access the network resource, and where the authentication reservation includes the device ID and an IP address from which the client device sent the device ID, user ID, and PIN. The authentication reservation may then be used by another server or process to authenticate the user when attempting to access the server or process. Various embodiments of the use of the authentication reservation may be found in the descriptions of FIGS. 1-6.

FIG. 10 is a flowchart illustrating a method 1000 for authenticating a user over a computer network, according to an embodiment. At block 1002, the server receives from a client device a request to access a network resource, where the request includes a unique device ID identifying the client device and a user ID. At block 1004, the server validates the request to produce a validated request. The validation may include validating that the device ID is correlated to the user ID. At block 1006, the validated request is stored and correlated with the device ID. At block 1008, the server receives a request to establish a connection to the network resource, where the request includes the device ID. At block 1010, the server validates the request to establish the connection by comparing the device ID with the device ID correlated with the validated request. When the request to establish the connection is validated, the server constructs, at block 1012, a connection between the client device and the network resource.

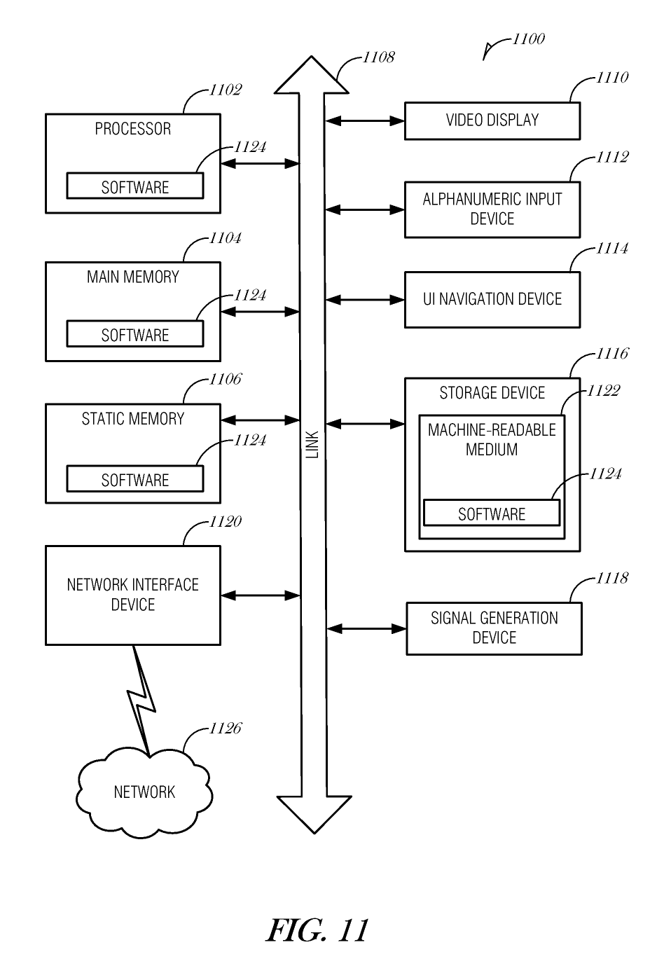

FIG. 11 is a block diagram illustrating a machine in the example form of a computer system 1100, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a PDA, a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1100 includes at least one processor 1102 (e.g., a central processing unit (CPU), a graphics processing unit (GPU) or both, processor cores, compute nodes, etc.), a main memory 1104 and a static memory 1106, which communicate with each other via a link 1108 (e.g., bus). The computer system 1100 may further include a video display unit 1110, an alphanumeric input device 1112 (e.g., a keyboard), and a user interface (UI) navigation device 1114 (e.g., a mouse). In one embodiment, the video display unit 1110, input device 1112, and UI navigation device 1114 are incorporated into a touch screen display. The computer system 1100 may additionally include a storage device 1116 (e.g., a drive unit), a signal generation device 1118 (e.g., a speaker), a network interface device 1120, and one or more sensors (not shown), such as a global positioning system (GPS) sensor, compass, accelerometer, or other sensor.

The storage device 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104, static memory 1106, and/or within the processor 1102 during execution thereof by the computer system 1100, with the main memory 1104, static memory 1106, and the processor 1102 also constituting machine-readable media.

While the machine-readable medium 1122 is illustrated in an example embodiment to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Although embodiments have been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include ROM, random-access memory (RAM), magnetic disk storage media, optical storage media, flash-memory devices, and other storage devices and media.

Examples, as described herein, can include, or can operate on, logic or a number of components, modules, or mechanisms. Modules are tangible entities (e.g., hardware) capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client, or server computer system) or one or more hardware processors can be configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as respective different modules at different times. Software can accordingly configure a hardware processor, for example, to constitute a particular module at one instance of time and to constitute a different module at a different instance of time.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of authenticating a user over a computer network, the method comprising:
receiving at a server, from a client device, a request to access a network resource, the request comprising:
a device identifier (ID) unique to the client device;
a user ID of the user; and
a personal identification number (PIN) of the user;
verifying the device ID and the PIN are associated with the user ID;
creating an authentication reservation for the device, the authentication reservation allowing the device to access the network resource, the authentication reservation comprising:
the device ID; and
an internet protocol (IP) address, from which the client device sent the device ID, user ID, and PIN;
receiving an attempt to access the network resource; and
granting the client device access to the network resource in response to matching the device ID with a device ID obtained from the attempt, and also matching the IP address with an IP address obtained from the attempt.

2. The method of claim 1, further comprising deleting, by the server, the authentication reservation after a period of time.

3. The method of claim 2, further comprising accessing a setting and configuring the period of time at the server.

4. The method of claim 1, further comprising denying the client device access to the network resource in response to the device ID in the authentication reservation not matching the device ID obtained from the attempt or the IP address in the authentication reservation not matching the IP address obtained from the attempt.

5. The method of claim 4, further comprising deleting the authentication reservation after a number of unsuccessful attempts to access the network resource, wherein an unsuccessful attempt to access the network resource comprises:
the device ID in the authentication reservation not matching the device ID obtained from the attempt, or
the IP address in the authentication reservation not matching the IP address obtained from the attempt.

6. The method of claim 5, further comprising accessing, at the server, a setting and configuring the number of unsuccessful attempts.

7. The method of claim 1, further comprising receiving, at the server, encrypted communications from the client device and sending, from the server, encrypted responses to the client device.

8. A computer system for user authentication comprising:
a processor; and
non-transitory computer executable instructions operative on the processor to:
receive at a server, from a client device, a request to access a network resource, the request comprising:
a device identifier (ID) unique to the client device;
a user ID of the user; and
a personal identification number (PIN) of the user;
verify the device ID and the PIN are associated with the user ID;
create an authentication reservation for the device, the authentication reservation allowing the device to access the network resource, the authentication reservation comprising:
the device ID; and
an internet protocol (IP) address, from which the client device sent the device ID, user ID, and PIN;
receive an attempt to access the network resource; and
grant the client device access to the network resource in response to matching the device ID with a device ID obtained from the attempt, and also matching the IP address with an IP address obtained from the attempt.

9. The computer system of claim 8, wherein the processor is further operative to delete the authentication reservation after a period of time.

10. The computer system of claim 9, wherein the processor is further operative to access a setting and configure the period of time.

11. The computer system of claim 8, wherein the processor is further operative to deny the client device access to the network resource in response to the device ID in the authentication reservation not matching the device ID obtained from the attempt or the IP address in the authentication reservation not matching the IP address obtained from the attempt.

12. The computer system of claim 11, wherein the processor is further operative to delete the authentication reservation after a number of unsuccessful attempts to access the network resource, wherein an unsuccessful attempt to access the network resource comprises:
the device ID in the authentication reservation not matching the device ID obtained from the attempt, or
the IP address in the authentication reservation not matching the IP address obtained from the attempt.

13. The computer system of claim 12, wherein the processor is further operative to access a setting and configure the number of unsuccessful attempts.

14. The computer system of claim 8, wherein the processor is further operative to receive encrypted communications from the client device and send encrypted responses to the client device.

15. A non-transitory computer readable medium including instructions to authenticate a user, which when executed by a computer, cause the computer to:
receive at a server, from a client device, a request to access a network resource, the request comprising:
a device identifier (ID) unique to the client device;
a user ID of the user; and
a personal identification number (PIN) of the user;
verify the device ID and the PIN are associated with the user ID;
create an authentication reservation for the device, the authentication reservation allowing the device to access the network resource, the authentication reservation comprising:
the device ID; and
an internet protocol (IP) address, from which the client device sent the device ID, user ID, and PIN;
receive an attempt to access the network resource; and
grant the client device access to the network resource in response to matching the device ID with a device ID obtained from the attempt, and also matching the IP address with an IP address obtained from the attempt.

16. The non-transitory computer readable medium of claim 15, further comprising instructions to delete the authentication reservation after a period of time.

17. The non-transitory computer readable medium of claim 16, further comprising instructions to access a setting and configure the period of time.

18. The non-transitory computer readable medium of claim 15, further comprising instructions to deny the client device access to the network resource in response to the device ID in the authentication reservation not matching the device ID obtained from the attempt or the IP address in the authentication reservation not matching the IP address obtained from the attempt.

19. The non-transitory computer readable medium of claim 18, further comprising instructions to delete the authentication reservation after a number of unsuccessful attempts to access the network resource, wherein an unsuccessful attempt to access the network resource comprises:
the device ID in the authentication reservation not matching the device ID obtained from the attempt, or
the IP address in the authentication reservation not matching the IP address obtained from the attempt.

20. The non-transitory computer readable medium of claim 19, further comprising instructions to access a setting and configure the number of unsuccessful attempts.
